(19) United States
(12) Patent Application Publication
(10) Pub. No.: US 2012/0135384 A1
(43) Pub. Date: May 31, 2012

(54) PORTABLE TERMINAL, CALORIE ESTIMATION METHOD, AND CALORIE ESTIMATION PROGRAM

(75) Inventor: Koji NAKAO, Tokyo (JP)

(73) Assignee: Terumo Kabushiki Kaisha, Shibuya-ku (JP)

(21) Appl. No.: 13/305,012

(22) Filed: Nov. 28, 2011

(30) Foreign Application Priority Data
Nov. 26, 2010 (JP) 2010-263850

(51) Int. Cl. G09B 19/00

(52) U.S. Cl. 434/127

(57) ABSTRACT

A portable terminal including: an imaging portion; a storage portion configured to store a database in which a plurality of foods and the calories thereof are associated with the shapes of containers and with the colors of the foods; a container detection portion configured to detect, from an image taken of a food slantwise at a predetermined angle to a horizontal direction, a container on which the food is placed; a container shape classification portion configured to classify the shape of the container detected by the container detection portion; a color detection portion configured to detect the container having been detected by the container detection portion; and a food estimation portion configured to estimate the food and the calories thereof from the database.

### TECHNICAL FIELD

The disclosure here generally relates to a portable terminal, a calorie estimation method, and a calorie estimation program. More particularly, the disclosure involves a portable terminal, a calorie estimation method, and a calorie estimation program for estimating the calories of a food of which an image is taken typically by a camera.

### BACKGROUND DISCUSSION

Recent years have witnessed the emergence of metabolic syndrome and lifestyle-related diseases as social issues. In order to prevent and/or improve such disorders as well as to look after health on a daily basis, it is considered important to verify and manage the caloric food intake.

Given such considerations, some devices have been proposed which emit near-infrared rays toward food to take a near-infrared image thereof. The image is then measured for the rate of absorption of the infrared rays into the food so as to calculate its calories. An example of this is disclosed in Japanese Patent Laid-open No. 2006-105655.

Other devices have also been proposed which take an image of a given food which is then compared with the previously stored images of numerous foods for similarity. The most similar of the stored images is then selected so that the nutritional ingredients of the compared food may be extracted accordingly. An example of this is disclosed in Japanese Patent Laid-open No. 2007-226621.

The above-cited type of device for emitting near-infrared rays toward the target and taking images thereof involves installing a light source for emitting near-infrared rays and a near-infrared camera for taking near-infrared images. That means an ordinary user cannot take such images easily.

Also, the above-cited type of device for comparing the image of a given food with the previously recorded images of a large number of foods involves storing the images in large data amounts. The technique entails dealing with enormous processing load from matching each taken image against the stored images. This can pose a serious problem particularly for devices such as portable terminals with limited storable amounts of data and restricted processing power.

### SUMMARY

Disclosed here is a portable terminal, a calorie estimation method, and a calorie estimation program for estimating the calories of a food by use of a relatively small amount of data involving reduced processing load without requiring a user to perform complicated operations.

According to one aspect disclosed here, a portable terminal includes: an imaging portion; a storage portion configured to store a database in which a plurality of foods and the calories thereof are associated with the shapes of containers and with the colors of the foods; a container detection portion configured to detect a container from an image taken by the imaging portion; a container shape classification portion configured to detect the shape of the container detected by the container detection portion; a color detection portion configured to detect as the color of a food the color of that area of the container on which the food is considered to be placed, the container having been detected by the container detection portion; and a food estimation portion configured to estimate the food and the calories thereof from the database, based on the shape of the container detected by the container detection portion and on the color of the food detected by the color detection portion.

With this portable terminal, the database in the storage portion may further associate a plurality of foods and the calories thereof with the colors of the containers; the color detection portion may further detect the color of the area considered to be the container; and the food estimation portion may estimate the food and the calories thereof from the database, based further on the color of the container.

According to another aspect, a calorie estimation method includes: detecting, from an image taken of a food slantwise at a predetermined angle to a horizontal direction, a container on which the food is placed; classifying the shape of the container detected in the container detecting step; detecting as the color of the food the color of that area of the container on which the food is considered to be placed, the container being detected in the container detecting step; and estimating the food and the calories thereof from a database in which a plurality of foods and the calories thereof are associated with the shapes of containers and with the colors of the foods, the estimation being based on the shape of the container detected in the container detecting step and on the color of the food detected in the color detecting step.

With this calorie estimation method, the color detecting step may further detect the color of the area considered to be the container; and the food estimating step may further estimate the food and the calories thereof from the database in which a plurality of foods and the calories thereof are further associated with the colors of containers.

According to a further aspect, a non-transitory calorie estimation program stored in a computer-readable medium for executing a procedure that includes: detecting, from an image taken of a food slantwise at a predetermined angle to a horizontal direction, a container on which the food is placed; classifying the shape of the container detected in the container detecting step; detecting as the color of the food the color of that area of the container on which the food is considered to be placed, the container being detected in the container detecting step; and estimating the food and the calories thereof from a database in which a plurality of foods and the calories thereof are associated with the shapes of containers and with the colors of the foods, the estimation being based on the shape of the container detected in the container detecting step and on the color of the food detected in the color detecting step.

With this calorie estimation program, the color detecting step may further detect the color of the area considered to be the container; and the food estimating step may further estimate the food and the calories thereof from the database in which a plurality of foods and the calories thereof are further associated with the colors of containers.

With the above-outlined aspects of the disclosure here, the user need only take a single image of foods to detect the shapes of containers in the image, the colors of the foods placed on the containers, and the colors of the containers. The foods are then detected and their calories are calculated based on the shapes and colors of the containers and on the colors of the foods placed on the containers.

The user need only take a single image of food(s) to detect the shapes of containers in the image, the colors of the foods placed on the containers, and the colors of the containers. The foods are then detected and their calories are calculated based on the shapes and colors of the containers and on the colors of the foods placed on the containers. Without performing complicated operations, the user can thus estimate the calories of given feeds using a limited amount of data involving reduced processing load.

### BRIEF DESCRIPTION OF THE DRAWINGS

FIGS. 1A and 1B are perspective views of an external structure of a portable terminal.

FIG. 2 is a schematic illustration of a circuit structure of the portable terminal.

FIG. 3 is a schematic illustration of a functional structure of a CPU.

FIG. 4 is an illustration of image of foods.

FIGS. 5A, 5B and 5C are illustrations of various container shapes.

FIGS. 6A, 6B, 6C, 6D and 6E are illustrations of other container shapes.

FIGS. 7A and 7B are illustrations of further container shapes.

FIG. 8 is an illustration of an elliptical area and a ringed area of a container.

FIG. 9 is a table illustrating a food estimation database.

FIG. 10 is a flowchart showing a calorie estimation process routine.

FIG. 11 is a flowchart showing a container shape classification process routine. and

FIG. 12 is a flowchart showing a learning process routine.

### DETAILED DESCRIPTION

Embodiments of the portable terminal, calorie estimation method, and calorie estimation program disclosed here are described below with reference to the accompanying drawings

### 1. Structure of the Portable Terminal

### 1-1. External Structure of the Portable Terminal

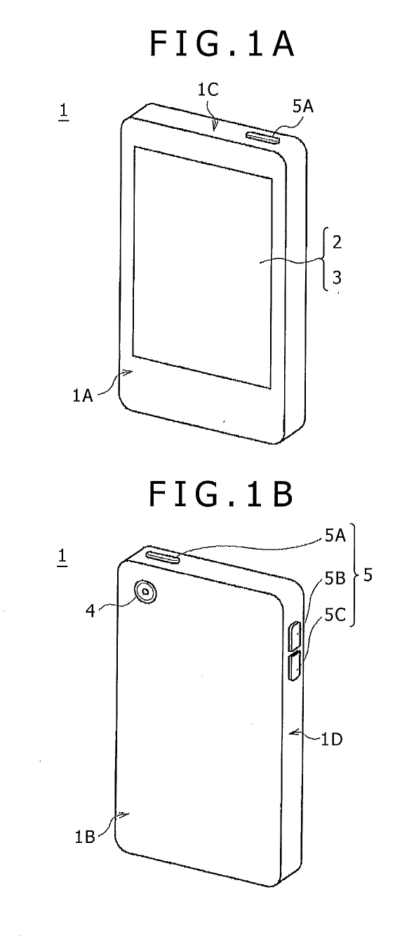

As shown in FIGS. 1A and 1B, a portable terminal 1 such as a mobile phone is substantially a palm-size flat-shaped rectangular solid terminal. A display portion 2 is attached to the front face 1A of the terminal 1, and a touch panel 3 for accepting a user's touch operations is mounted on the top surface of the display portion 2.

A liquid crystal display, an organic EL (electro-luminescence) display or the like may be used as the display portion 2. The touch panel 3 may operate from the resistance film method, electrostatic capacitance method or the like.

A camera 4 is attached to the backside 1B of the portable terminal 1. Also, a shutter button 5A for causing the camera 4 to start taking an image is mounted on the topside 1C of the portable terminal 1. A zoom-in button 5B and a zoom-out button 5C for changing zoom magnification are furnished on the lateral side 1D of the portable terminal 1.

The shutter button 5A, zoom-in button 5B, and zoom-out button 5C are collectively called the operation buttons 5.

### 1-2. Circuit Structure of the Portable Terminal

As shown in FIG. 2, the portable terminal 1 includes a CPU (central processing unit) 11, a RAM (random access memory) 12, a ROM (read only memory) 13, an operation input portion 14, an imaging portion 15, a storage portion 16, and the display portion 2 interconnected via a bus 17 inside the terminal.

The CPU 11 provides overall control of the portable terminal 1 by reading basic programs from the ROM 13 into the RAM 12 for execution. The CPU 11 also performs diverse processes by reading various applications from the ROM 13 into the RAM 12 for execution.

The operation input portion 14 is made up of the operation buttons 5 and the touch panel 3. The imaging portion 15 is composed of the camera 4 and an image processing circuit 18 that converts what is taken by the camera 4 into an image and also carries out diverse image processing. A nonvolatile memory or the like may be used as the storage portion 16.

### 2. Calorie Estimation Process

Set forth next is an explanation of a calorie estimation process carried out by the portable terminal 1. The CPU 11 executes the calorie estimation process by reading a calorie estimation processing program from the ROM 13 into the RAM 12 for execution.

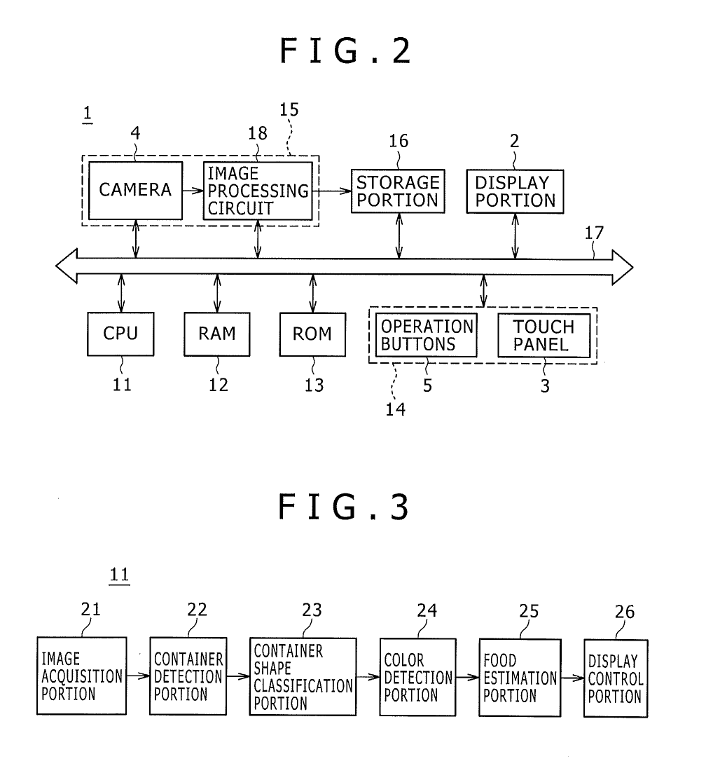

Upon executing the calorie estimation process, the CPU 11 functions or operates as an imaging portion or image acquisition portion 21, a container detection portion 22, a container shape classification portion 23, a color detection portion 24, a food estimation portion 25, and a display control portion 26, as shown in FIG. 3.

When carrying out the calorie estimation process, the image acquisition portion 21 may cause the display portion 2 to display messages such as a message “Please take an image slantwise so that the entire food can be covered,” while controlling the imaging portion 15 to capture the image. Taking an image slantwise refers to taking an oblique perspective image of the entire food.

The image acquisition portion 21 may then prompt the user to adjust the angle of view by operating the zoom-in button 5B or zoom-out button 5C so that the entire food may be imaged slantwise (e.g., at 45 degrees to the horizontal direction) and to press the shutter button 5A while the food as a whole is being imaged slantwise or as an oblique perspective.

When the user sets the angle of view by operating the zoom-in button 5B or zoom-out button 5C and then presses the shutter button 5A, the imaging portion 15 using its AF (auto focus) function focuses the camera 4 on the food of interest. The imaging portion 15 then causes an imaging element of the camera 4 to form an image out of the light from the object (food). The image is subjected to photoelectric conversion whereby an image signal is obtained. The resulting image signal is forwarded to the image processing circuit 18.

The image processing circuit 18 performs image processing on the image signal from the camera 4, before submitting the processed signal to analog-to-digital (A/D) conversion to generate image data.

The image acquisition portion 21 displays on the display portion 2 an image corresponding to the image data generated by the image processing circuit 18. At the same time, the image acquisition portion 21 stores, in the storage portion 16, image information such as the use or nonuse of a flash upon image-taking by the camera 4 associated with the image represented by the image data, using Exif (Exchangeable Image File Format) for example.

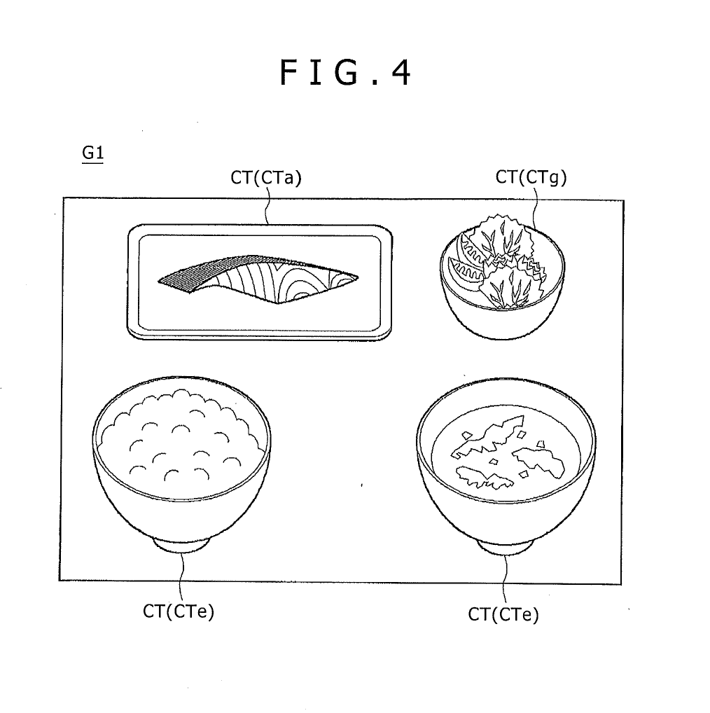

From the storage portion 16, the container detection portion 22 may read the image data of a food image G1 representing all foods as shown in FIG. 4. From the food image G1, the container detection portion 22 may then detect containers CT (CTa, CTb, . . . ) on which or in which the foods are placed.

More specifically, the container detection portion 22 may perform an edge detection process on the food image G1 in order to detect as the containers CT the areas having predetermined planar dimensions and surrounded by edges indicative of the boundaries between the containers and the background. As another example, the container detection portion 22 may carry out Hough transform on the food image G1 to detect straight lines and/or circles (curves) therefrom so that the areas having predetermined planar dimensions and surrounded by these straight lines and/or circles (curves) may be detected as the containers CT. Alternatively, the containers CT may be detected from the food image G1 using any other suitable method.

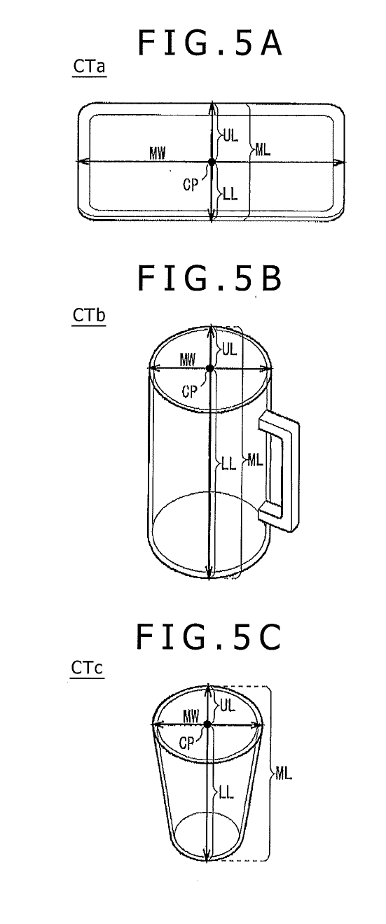

As shown in FIGS. 5A through 7B, the container shape classification portion 23 detects the pixel row and the pixel column having the largest number of pixels each in the detected container CT as the maximum width MW and the maximum length ML thereof. Also, the container shape classification portion 23 calculates the measurements of the detected maximum width MW and maximum length ML based on the relationship between the number of pixels in each of the maximum width MW and maximum length ML on the one hand, and the focal length related to the food image G1 on the other hand.

Furthermore, the container shape classification portion 23 detects the point of intersection between the maximum width MW and the maximum length ML as a center point CP of the container CT.

If the container CT is a round plate, a bowl, a rice bowl, a mini bowl, a glass, a jug or the like, the maximum width MW represents the diameter of the container CT in question. If the container CT is a rectangle plate, the maximum width MW represents one of its sides. Where the container CT is a round plate, a bowl, a rice bowl, a mini bowl, a glass, a jug or the like, the center point CP represents the center of the opening of the container CT.

Meanwhile, the containers used for meals may be roughly grouped into rectangle plates, round plates, bowls, rice bowls, mini bowls, glasses, jugs, cups and others.

Thus the container shape classification portion 23 may classify the container CT detected by the container detection portion 22 as a rectangle plate, a round plate, a bowl, a rice bowl, a mini bowl, a glass, a jug, a glass, or some other container, for example.

The container shape classification portion 23 detects straight line components from the edges detected in the above-mentioned edge detection process as representative of the contour of the container CT detected by the container detection portion 22. If the container CT has four such straight line components, the container shape classification portion 23 classifies the container CT as a rectangle plate CTa such as one shown in FIG. 5A.

If the container CT is something other than the rectangle plate CTa, the container shape classification portion 23 calculates the ratio of the maximum length ML to the maximum width MW of the container CT (called the aspect ratio hereunder). The container shape classification portion 23 then determines whether the calculated aspect ratio is larger or smaller than a predetermined aspect ratio threshold.

The aspect ratio threshold is established to distinguish round plates, bowls, rice bowls, cups, mini bowls and others from glasses and jugs. Glasses and jugs are generally long and slender in shape with their maximum width MW smaller than their maximum length ML, as opposed to the other containers not slender in shape with their maximum length ML smaller than or equal to their maximum width MW. The aspect ratio threshold is established in a manner permitting classification of these containers.

Thus if it is determined that the container CT has an aspect ratio larger than the aspect ratio threshold, the container CT may be classified as a glass or as a jug. If the container CT is determined to have an aspect ratio smaller than the aspect ratio threshold, that container CT may be classified as any one of a round plate, a bowl, a rice bowl, a cup, a mini bowl, and some other container.

The container CT of which the aspect ratio is determined to be larger than the aspect ratio threshold is either a cup or a jug. Its size may also be used as a rough basis for classifying the container CT. Given a container CT whose aspect ratio is determined larger than the aspect ratio threshold and whose maximum width MW is determined larger than a boundary length (threshold or boundary length threshold) distinguishing a glass from a jug, the container shape classification portion 23 may typically classify the container CT as a jug CTb. If the container CT has a maximum width MW determined smaller than the boundary length, then the container shape classification portion 23 may typically classify the container CT as a glass CTc.

The container shape classification portion 23 calculates an upper length UL above the center point CP of the maximum length of the container CT whose aspect ratio is determined smaller than the aspect ratio threshold, as well as a lower length LL below that center point CP. The container shape classification portion 23 thus calculates the ratio of the upper length UL to the lower length LL (called the upper-to-lower ratio hereunder).

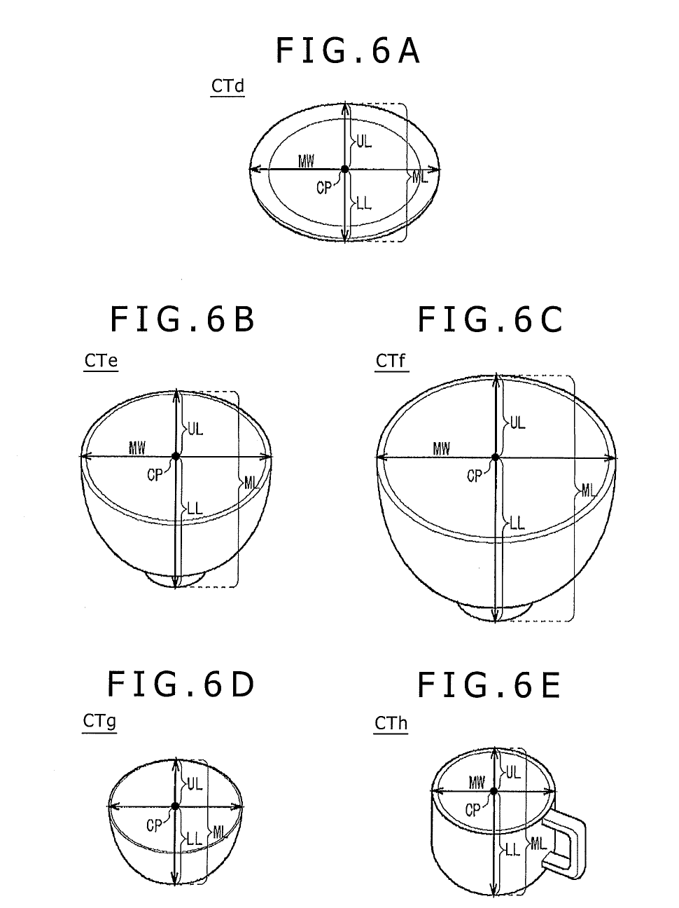

If a round plate CTd is shallow and flat in shape as shown in FIG. 6A and if an image is taken of it slantwise (in oblique perspective), the upper length UL may be substantially equal to or smaller than the lower length LL in the image.

On the other hand, as shown in FIGS. 6B through 6E, a bowl CTe, a rice bowl CTf, a mini bowl CTg, and a cup CTh are each deeper than the round plate CTd in shape. If an image is taken of any one of these containers, its lower length LL appears longer than its upper length UL in the image.

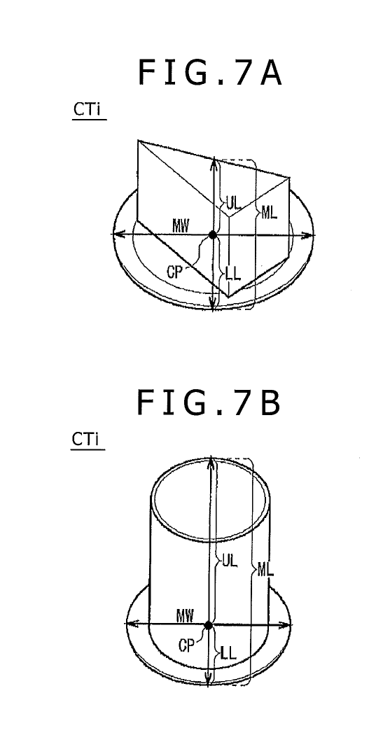

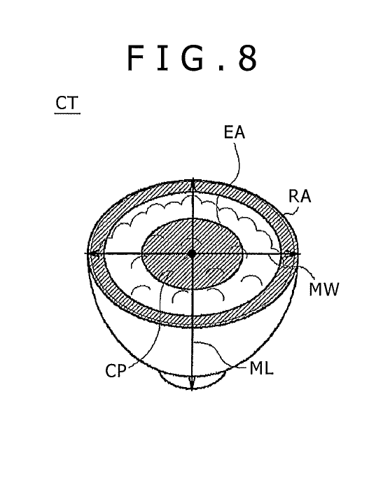

Also, as shown in FIG. 7A, if a food having a certain height such as a piece of cake is placed on a round plate, an image taken of the plate slantwise (in oblique perspective) shows part of the food to be higher than the round plate. In that case, part of the food is also detected by the container detection portion 22 as it detects the round plate, so that the lower length LL appears smaller than the upper length UL in the image.

Furthermore, as shown in FIG. 7B, if a container carrying a steamed egg hotchpotch or the like is placed on a saucer whose diameter is larger than that of the container on top of it, the diameter of the saucer is measured as the maximum width. In this case, the lower length LL appears shorter than the upper length UL.

Thus based on the upper-to-lower ratio, the container shape classification portion 23 can classify the container CT of interest as either any one of a round plate CTd, a bowl CTe, a rice bowl CTf, a mini bowl CTg, a cup CTh; or some other container CTi.

The container shape classification portion 23 proceeds to compare the calculated upper-to-lower ratio of the container CT in question with a first and a second upper-to-lower ratio threshold. The first upper-to-lower ratio threshold is set to a boundary ratio separating the upper-to-lower ratio of some other container CTi (of which the lower length LL is smaller than the upper length) from the upper-to-lower ratio of the round plate CTd. The second upper-to-lower ratio threshold is set to a boundary ratio separating the upper-to-lower ratio of the round plate CTd from the upper-to-lower ratio of the bowl CTe, rice bowl CTf, mini bowl CTg, or cup CTh.

If the comparison above shows the upper-to-lower ratio of the container CT to be smaller than the first upper-to-lower ratio threshold, the container shape classification portion 23 classifies the container CT as some other container CTi. If the upper-to-lower ratio of the container CT is determined larger than the first upper-to-lower ratio threshold and smaller than the second upper-to-lower ratio threshold, the container shape classification portion 23 classifies the container CT as a round plate CTd. Furthermore, if the comparison shows the upper-to-lower ratio of the container CT of interest to be larger than the second upper-to-lower ratio threshold, the container shape classification portion 23 classifies the container CT as any one of a bowl CTe, a rice bowl CTf, a mini bowl CTg, and a cup CTh.

If the container CT of interest is classified as any one of a bowl CTe, a rice bowl CTf, a mini bowl CTg, and a cup CTh, the container shape classification portion 23 then compares the maximum width (i.e., diameter) of the container CT with predetermined diameters of the bowl CTe, rice bowl CTf, mini bowl CTg, and cup CTh, thereby classifying the container CT definitely as a bowl CTe, a rice bowl CTf, a mini bowl CTg, or a cup CTh. The terminal, method and program here thus classify the container CT detected by the container detection portion 22 as a rectangular plate CTa, a jug CTb, a glass CTc, a round plate CTd, a bowl CTe, a rice bowl CTf, a mini bowl CTg, a cup CTh, or some other container CTi.

As shown in FIG. 8, the color detection portion 24 detects as the food color the color component of an elliptical area EA of which the major axis may be, say, 60 percent of half the maximum width bisected by the center point CP of the container CT and of which the minor axis may be 60 percent of the shorter of the upper and the lower lengths UL and LL of the container CT.

Also, where the container CT is something other than the jug CTb or glass CTc, the color detection portion 24 detects as the color of the container CT the color component of a ringed area RA which exists outside the elliptical area EA and of which the width may be, say, 20 percent of half the maximum width between the outer edge of the container CT and the center point CP.

With the center point CP located at the center of the opening of the container CT, the elliptical area EA is an area on which the food is considered to be placed in a manner centering on the center point CP. Thus detecting the color component of the elliptical area EA translates into detecting the color of the food.

The ringed area RA is located outside the elliptical area EA and along the outer edge of the container CT and constitutes an area where no food is considered to be placed. Thus detecting the color component of the ringed area RA translates into detecting the color of the container CT. Meanwhile, jugs CTb and glasses CTc are mostly made from transparent glass. For that reason, the color detection portion 24 considers the color of the jug CTb or glass CTc to be transparent without actually detecting the color of the ringed area RA.

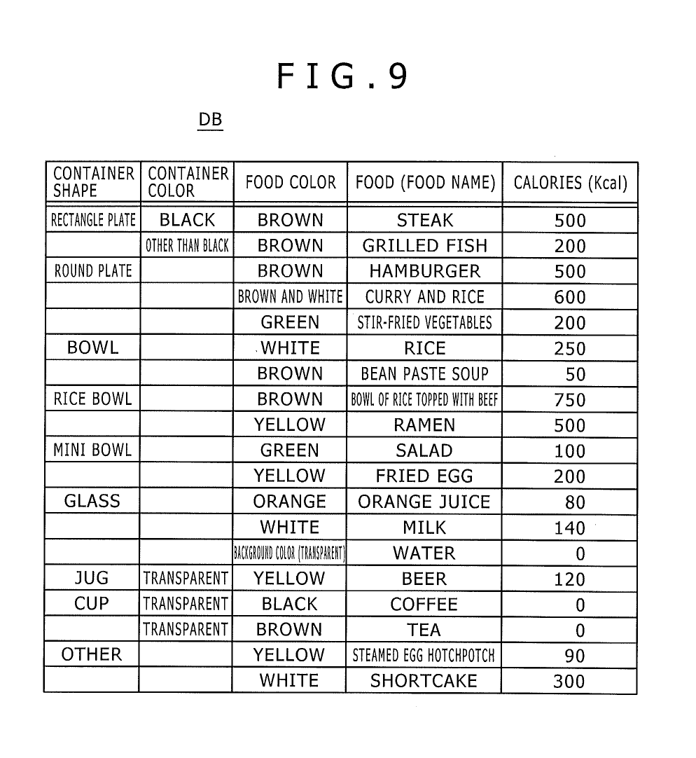

Given the shape of the container CT classified by the container shape classification portion 23 and the color of the food and/or that of the container CT detected by the color detection portion 24, the food estimation portion 25 estimates the food placed on the container CT and its calories in reference to a food estimation database DB such as one shown in FIG. 9. The food estimation database DB is stored beforehand in the storage portion 16. In the database DB, for example, dozens of foods (food names) and the calories thereof may be associated with the shapes and colors of containers and with food colors.

Also, the food estimation database DB may store numerous foods and their calories with which the shapes and colors of containers as well as food colors have yet to be associated. In a learning process, to be discussed later, the user can perform operations to associate a given food and its calories with the shape and color of the container as well as with the food color.

Thus the food estimation portion 25 searches the food estimation database DB for any given food and its calories that may match the shape of the container CT classified by the container shape classification portion 23 and the color of the food and/or that of the container CT detected by the color detection portion 24 in combination. The matching food and its calories are estimated by the food estimation portion 25 to be the food placed on the container CT and its calories. For example, if it is determined that the container CT is a “round plate” in shape and that the color of the food placed on the container is “brown,” the food estimation portion 25 may estimate the food in question to be a “hamburger” and its calories to be “500 Kcal.”

Then the food estimation portion 25 associates the food image G1 with the estimated food found in the food image G1 and the calories of the food as well as the date and time at which the food image G1 was taken, before adding these items to a calorie management data held in the storage portion 16.

The display control portion 26 superimposes the name of the food estimated by the food estimation portion 25 as well as the calories of the food on the displayed food image G1 in a manner close to the corresponding container CT appearing therein.

It might happen that a single meal involves having a plurality of foods served over time. In such a case where a plurality of food images G1 are taken within, say, one hour, the food estimation portion 25 stores the multiple food images G1 in association with one another as representative of a single meal.

It might also happen that a period of, say, one week is selected in response to the user's input operations on the operation input portion 14. In that case, the display control portion 26 reads from the calorie management database the calories of each of the meals taken during the week leading up to the current date and time taken as a temporal reference, and displays a list of the retrieved calories on the display portion 2.

In the manner described above, the user can readily know the foods he or she consumed along with their calories during the period of interest. If the estimated food turns out to be different from the actual food, the user may perform the learning process, to be discussed later, to make the portable terminal change the estimate and learn the food anew.

In the above-described calorie estimation process based on the color of the food being targeted and on the shape and color of the container carrying the food, the food in question can only be estimated approximately.

However, for the user to be able to record the calories taken at every meal without making complicated operations, it is important that the portable terminal 1 such as a carried-around mobile phone with low computing power and a limited data capacity should be capable of estimating calorie content from a single photo taken of the meal.

That is, for health management purposes, it is important that caloric intake be recorded at every meal at the expense of a bit of precision. Thus the disclosure here proposes ways to roughly estimate the meal of which a single food image G1 is taken in order to calculate the calories involved. On the other hand, some users may desire to have foods and their calories estimated more precisely. That desire can be met by carrying out the learning process to learn a given food on the container CT appearing in the food image G1, whereby the accuracy of estimating the food and its calories may be improved.

### 3. Learning Process

The CPU 11 performs the learning process by reading a learning process program from the ROM 13 into the RAM 12 for execution. When executing the learning process, the CPU 11 functions as a learning portion.

When the food image G1 targeted to be learned is selected from the calorie management database held in the storage portion 16 in response to the user's input operations on the operation input portion 14, the CPU 11 superimposes the name of the food and its calories associated with the food image G1 on the food image G1 displayed on the display portion 2.

When one of the containers CT appearing in the food image G1 is selected typically by the user's touch on the touch panel 3, the CPU 11 causes the display portion 2 to display a list of the food names retrieved from the food estimation database DB and prompts the user to select the food placed on the selected container CT.

When one of the listed food names is selected typically through the touch panel 3, the CPU 11 associates the selected food and its calories with the shape and color of the container CT as well as with the color of the food before adding these items to the list in the food estimation database DB.

In the manner explained above, if the food name estimated by the food estimation portion 25 is not correct, the food name can be corrected and added to the food estimation database DB. This makes it possible to boost the accuracy of estimating foods from the next time onwards.

The learning process is particularly effective if the user frequents his or her favorite eatery for example, since the establishment tends to serve the same foods on the same containers every time.

### 4. Caloric Estimation Process Routine

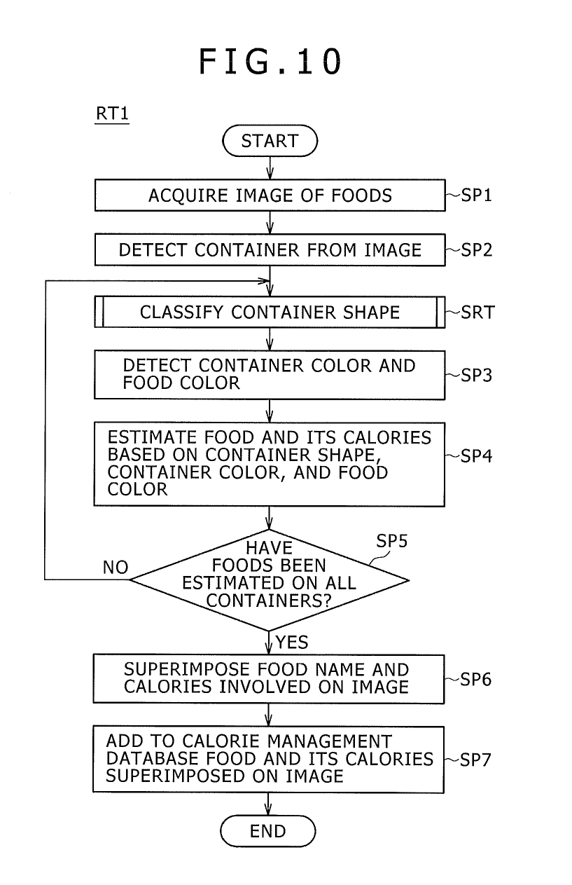

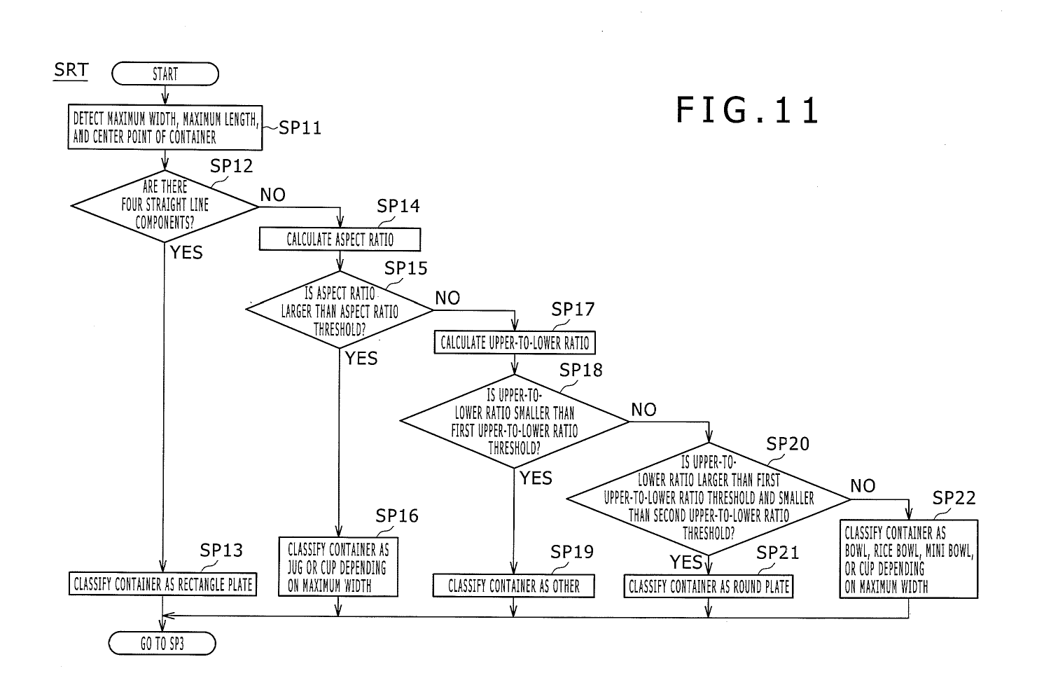

An example of a routine constituting the above-described calorie estimation process will now be explained with reference to the flowcharts of FIGS. 10 and 11.

From the starting step of the routine RT1, the CPU 11 enters step SP1 to acquire a food image G1 taken slantwise of the entire food being targeted. From step SP1, the CPU 11 goes to step SP2.

In step SP2, the CPU 11 detects a container CT from the food image G1. From step SP2, the CPU 11 goes to a subroutine SRT to classify the shape of the container CT in question. In the subroutine SRT (FIG. 11), the CPU 11 enters step SP11 to detect the maximum width MW, maximum length ML, and center point CP of the container CT appearing in the food image G1. From step SP11, the CPU 11 goes to step SP12.

In step SP12, the CPU 11 determines whether the contour of the container CT has four straight line components. If the result of the determination in step SP12 is affirmative, the CPU 11 goes to step SP13 to classify the container CT as a rectangle plate CTa. If the result of the determination in step SP12 is negative, the CPU 11 goes to step SP14.

In step SP14, the CPU 11 calculates the aspect ratio of the container CT. The CPU 11 then goes to step SP15 to determine whether the calculated aspect ratio is larger than a predetermined aspect ratio threshold. If the result of the determination in step SP15 is affirmative, the CPU 11 goes to step SP16 to classify the container CT as a jug CTb or a glass CTc depending on the maximum width MW.

If the result of the determination in step SP15 is negative, the CPU 11 goes to step SP17 to calculate the upper-to-lower ratio of the container CT. From step SP17, the CPU 11 goes to step SP18 to determine whether the calculated upper-to-lower ratio is smaller than a first upper-to-lower ratio threshold. If the result of the determination in step SP18 is affirmative, the CPU 11 goes to step SP19 to classify the container CT as some other container CTi.

If the result of the determination in step SP18 is negative, the CPU 11 goes to step SP20 to determine whether the calculated upper-to-lower ratio is larger than the first upper-to-lower ratio threshold and smaller than a second upper-to-lower ratio threshold.

If the result of the determination in step SP20 is affirmative, the CPU 11 goes to step SP21 to classify the container CT as a round plate CTd. If the result of the determination in step SP20 is negative, the CPU 11 goes to step SP22 to classify the container CT as a bowl CTe, a rice bowl CTf, a mini bowl CTg, or a cup CTh depending on the maximum width MW of the container CT (i.e., its diameter).

Upon completion of the subroutine SRT, the CPU 11 goes to step SP3. In step SP3, the CPU 11 detects the color component of the elliptical area EA and that of the ringed area RA of the container CT as the color of the food and that of the container CT, respectively. From step SP3, the CPU 11 goes to step SP4.

In step SP4, given the shape of the container CT and the color of the food and/or that of container CT, the CPU 11 estimates the food and its calories in reference to the food estimation database DB. From step SP4, the CPU 11 goes to step SP5.

In step SP5, the CPU 11 determines whether the foods on all containers CT appearing in the food image G1 as well as the calories of the foods have been estimated. If there remains any container CT carrying the food and its calories yet to be estimated, the CPU 11 performs the subroutine SRT and steps SP3 and SP4 on all remaining containers CT so that the foods placed thereon and their calories may be estimated.

If it is determined in step SP5 that the foods placed on all containers CT and their calories have been estimated, the CPU 11 goes to step SP6. In step SP6, the CPU 11 superimposes the names of the foods and their calories on the displayed food image G1. From step SP6, the CPU 11 goes to step SP7.

In step SP7, the CPU 11 associates the food image G1 with the estimated foods and their calories in the food image G1 as well as with the date and time at which the food image G1 was taken, before adding these items to the calories management database. This completes the execution of the routine RT1.

### 5. Learning Process Routine

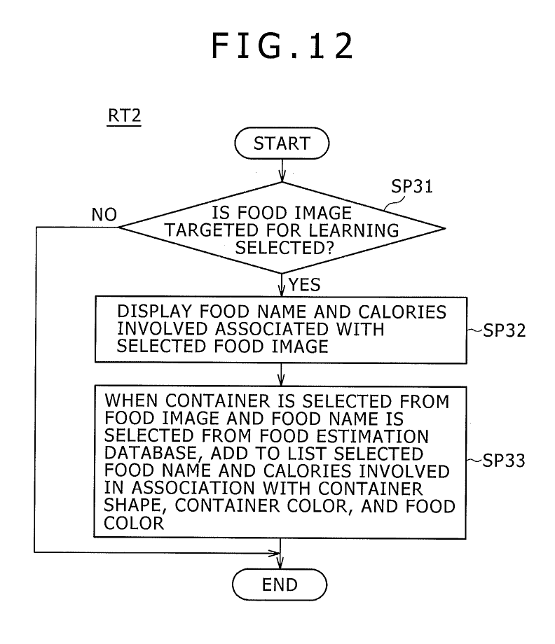

An example of a routine constituting the above-mentioned learning process will now be explained with reference to the flowchart of FIG. 12.

From the starting step of the routine RT2, the CPU 11 enters step SP31 to determine whether the food image G1 targeted to be learned is selected from the caloric management database. If it is determined that the target food image G1 is selected, the CPU 11 goes to step SP32 to superimpose the names of the foods and their calories associated with the food image G1 being displayed. From step SP32, the CPU 11 goes to step SP33.

In step SP33, when one of the containers CT appearing in the food image G1 is selected, the CPU 11 displays a list of food names retrieved from the food estimation database DB. When one of the listed food names is selected, the CPU 11 associates the selected name of the food and its calories with the shape and color of the selected container CT as well as with the color of the food, before adding these items to the list of the food estimation database DB. This completes the execution of the routine RT2.

### 6. Operations and Effects

The portable terminal 1 structured as discussed above detects a container CT from the food image G1 taken slantwise (in oblique perspective) by the imaging portion 15 of the food placed on the container CT, classifies the shape of the detected container CT, and detects the color of the container CT and that of the food carried thereby.

The portable terminal 1 proceeds to estimate the food placed on the container CT and the calories of the food, based on the shape of the container CT and on the color of the food and/or that of the container CT following retrieval from the food estimation database DB in which a plurality of foods and their calories are associated with the shapes of containers and the colors of the foods and/or those of the containers.

In the manner explained above, the user of the portable terminal 1 need only take a single food image G1 of the target food at a predetermined angle to the horizontal direction, and the portable terminal 1 can estimate the food and its calories from the image. The portable terminal 1 thus allows the user easily to have desired foods and their calories estimated without performing complicated operations.

Also, since the portable terminal 1 estimates a given food and its calories based on the shape of the container CT carrying the food and on the color of the food and/or that of container CT, the portable terminal 1 deals with appreciably less processing load and needs significantly less data capacity than if the taken image were to be checked against a large number of previously stored food images for a match as in ordinary setups.

The portable terminal 1 detects a container CT from the food image G1 taken slantwise (in oblique perspective) by the imaging portion 15 of the food placed on the container CT, detects the shape of the container CT and the color of the food placed on the container CT and/or the color of container CT, and estimates the food and its calories using the food estimation database dB in accordance with the detected shape of the container CT, the detected color of the food, and/or the detected color of the container CT. The user need only perform the simple operation of taking an image G1 of the target food, and the portable terminal 1 takes over the rest under decreased processing load using a reduced data capacity.

The embodiment of the calorie-estimating portable terminal described above by way includes the CPU 11 which is an example of image acquisition means for acquiring/processing an image corresponding to the image data generated by the image processing circuit 18, and container detecting means for detecting, based on an image of a food item taken slantwise or from a perspective at an angle (non-zero predetermined angle) to a horizontal direction, a container on which the food is placed. The CPU 11 is also an example of classifying means for classifying the shape of the container detected by the container detection means, and also an example of color detection means for detecting as the color of the food the color of an area of the container on which the food is considered to be placed. The CPU 11 is also an example of food estimation portion means for estimating the food and the associated calories from the database, based on the shape of the container detected by the container detection portion and based on the color of the food detected by the color detection portion. The CPU 11 additionally represents an example of display control means for displaying a list of food names from the database for selection by a user to identify one of the food names representing the food in the container that is to be calorically estimated, and learning means for adding to the database the food corresponding to the selected food name and the calories thereof in association with the shape of the container selected by the user and the color of the food.

### 7. Other Embodiments and Variations

With the above-described embodiment, the method of classifying the container CT was shown to involve detecting straight line components from the edges (i.e., contour) of the container CT. As explained, if there are four straight line components in the contour, the container CT is classified as a rectangle or rectangular plate CTa. Alternatively, a Hough transform may be performed on the food image G1 to detect containers CT therefrom. Of the containers Ct thus detected, one with at least four straight lines making up its contour may be classified as the rectangle or rectangular plate CTa.

As another alternative, the containers CT detected from the food image G1 may be subjected to rectangle or rectangular pattern matching. Of these containers CT, one that has a degree of similarity higher than a predetermined threshold may be classified as the rectangle or rectangular plate CTa.

In the embodiment described above, each container CT is classified as a certain type of vessel, prior to the detection of the color of the container CT in question and that of the food placed thereon. Alternatively, the color of the container CT and that of the food placed thereon may be first detected, followed by the classification of the container CT as a certain type of vessel. In this case, the color detection portion 24 may calculate the maximum width MW and maximum length ML of the container CT and also detect the center point CP thereof.

With the above-described embodiment, the food placed on a given container CT and the calories of the food were shown estimated from the food estimation database DB in accordance with the shape of the container CT in question and with the color of the container CT and that of the food. Alternatively, if the portable terminal 1 is equipped with a GPS capability, the GPS may be used first to acquire the current location of the terminal 1 where the food image G1 has been taken, so that the current location may be associated with the food image G1. In the subsequent learning process, the current location may be associated with the food and its calories in addition to the shape of the container CT and the color of the container CT and that of the food placed thereon. This makes it possible to estimate more precisely the foods served at the user's favorite eatery, for example.

With the above-described embodiment, the food placed on the container CT was shown estimated from the food estimation database DB. Alternatively, if the combination of the shape of the detected container CT, of the color of the container CT in question, and of the color of the food placed thereon cannot be determined from the food estimation database DB, the user may be prompted to make selections through the touch panel 3.

In the immediately preceding example, the CPU 11 may display on the display portion 2 the container CT carrying the food that, along with its calories, cannot be estimated, while also displaying such food candidates as Western foods, Japanese foods, Chinese foods, and noodles to choose from. In this case, not all food names but about 20 food candidates may be retrieved from the food estimation database DB for display so that the user need not perform complicated operations when making the selections.

With regard to the embodiments discussed above, the CPU 11 was shown carrying out the aforementioned various processes in accordance with the programs stored in the ROM 13. Alternatively, the diverse processing above may be performed using the programs installed from suitable storage media or downloaded over the Internet. As another alternative, the various processes may be carried out using the programs installed over many other routes and channels.

The disclosure here may be implemented in the form of portable terminals such as mobile phones, PDAs (personal digital assistants), portable music players, and video game consoles for example.

The detailed description above describes features and aspects of embodiments of a portable terminal, caloric estimation method, and caloric estimation program disclosed by way of example. The invention is not limited, however, to the precise embodiments and variations described. Various changes, modifications and equivalents could be effected by one skilled in the art without departing from the spirit and scope of the invention as defined in the appended claims. It is expressly intended that all such changes, modifications and equivalents which fall within the scope of the claims are embraced by the claims.

What is claimed is:

1. A portable terminal comprising:
an imaging portion configured to acquire an image of food to be calorically estimated;
a stored database of a plurality of foods and calories of each of the foods in the database, the foods in the database each being associated with shapes of containers and colors of the foods;
a container detection portion configured to detect, based on an image of the food to be calorically estimated taken slantwise at an angle to a horizontal direction, a container on which the food to be calorically estimated is placed;
a container shape classification portion configured to classify a shape of the container detected by the container detection portion;
a color detection portion configured to detect, as the color of the food to be calorically estimated, the color of an area of the container on which the food to be calorically estimated is considered to be placed; and
a food estimation portion configured to estimate the food to be calorically estimated and the calories of the food to be calorically estimated from the database, using the shape of the container detected by the container detection portion and the color of the food detected by the color detection portion.

2. The portable terminal according to claim 1, wherein the container shape classification portion detects a maximum width and a maximum length of the container detected by the container detection portion in order to classify the shape of the container based on a ratio of the width to the length.

3. The portable terminal according to claim 2, wherein the container shape classification portion detects a center point at which the width and the length intersect, and classifies the shape of the container according to a ratio of an upper segment to a lower segment, wherein the upper segment is an entire portion of the maximum length above the center point and the lower segment is an entire portion of the maximum length below the center point.

4. The portable terminal according to claim 1, wherein the database also associates the foods and the calories with container colors, wherein the color detection portion further detects the color of an area considered to be the container, and wherein the food estimation portion estimates the food to be calorically estimated and the calories from the database using the container color.

5. The portable terminal according to claim 4, wherein the container shape classification portion detects a center point at which intersect the width and the length of the container detected by the container detection portion, and wherein the color detection portion detects a color component of a predetermined inner area around the center point as the color of the food, and a color component of a predetermined outer area outside the predetermined inner area on said container as the color of said container.

6. The portable terminal according to claim 1, further comprising:
a display control portion configured to display a list of food names from the database for selection by a user to identify one of the food names representing the food to be calorically estimated which is contained in the container; and
a learning portion configured such that when one of the food names is selected from said list, the learning portion adds to the database the food corresponding to the selected food name and the calories of the selected food name in association with the container shape selected by the user and the color of the food.

7. A calorie estimation method comprising:
detecting a container on which food is placed using an image of the food taken slantwise at an angle to a horizontal direction;
classifying a shape of the detected container;
detecting a color of the food on the container by detecting the color of an area of the detected container on which the food is considered to be placed; and
estimating the food on the container and the calories of the food on the container using a database of foods associated with container shapes and food colors, the foods in the database each having an associated amount of calories, the estimating of the food on the container being based on a comparison of the classified shape of the detected container and the detected color of the food on the container.

8. The method according to claim 7, wherein the classifying of the shape of the detected container comprises detecting whether the image includes a plurality of straight line components, and classifying the container as a rectangular plate when the image includes a plurality of straight line components.

9. The method according to claim 7, wherein the classifying of the shape of the detected container comprises detecting a maximum width and a maximum length of the detected container.

10. The method according to claim 9, wherein the classifying of the container comprises determining whether a ratio of the maximum length to the maximum width is larger than an aspect ratio threshold.

11. The method according to claim 9, wherein the classifying of the container comprises classifying the container as a first type of container if a ratio of the maximum length to the maximum width is larger than an aspect ratio threshold, and classifying the container as a second type of container if the ratio of the maximum length to the maximum width is smaller than the aspect ratio threshold.

12. The method according to claim 9, wherein the classifying of the container shape comprises detecting a center point at which the maximum length and the maximum width intersect, and wherein the classifying of the container comprises classifying the shape of the container according to a ratio of an upper segment to a lower segment, wherein the upper segment is an entire portion of the maximum length above the center point and the lower segment is an entire portion of the maximum length below the center point

13. The method according to claim 7, further comprising detecting a color of an area considered to be the container, and wherein the estimating of the food includes comparing the detected color of the area considered to be the container, and comparing the detected color of the area considered to be the container with container colors in the database associated with the foods in the database.

14. The method according to claim 13, wherein the classifying of the container shape comprises detecting a center point at which the maximum length and the maximum width intersect, wherein the detecting of the color of the food comprises detecting a color of a predetermined inner area around the center point as the color of the food, and detecting a color of a predetermined outer area outside the predetermined inner area as the color of the area considered to be the container.

15. The method according to claim 7, wherein the classifying of the container shape comprises detecting a center point at which the maximum length and the maximum width intersect, and wherein the detecting of the color of the food comprises detecting a color of a predetermined inner area around the center point as the color of the food.

16. The method according to claim 7, further comprising displaying a list of individually selectable food names from the database, and adding to the database the food corresponding to a selected one of the food names and the calories of the selected food name in association with the container shape selected by the user and the color of the food.

17. A non-transitory calorie estimation program stored in a computer readable medium for causing a computer to execute a procedure comprising:
detecting, from an image of food taken slantwise at an angle to a horizontal direction, a container on which the food is located;
classifying a shape of the detected container;
detecting, as a color of the food on the container, the color of an area of the detected container on which the food is considered to be placed; and
estimating the food and calories of the food by comparing the classified shape of the container and the detected color of the food to a database in which is stored a plurality of foods and the calories of the foods, with each of the foods stored in the database and the calories of the foods stored in the database being associated with shapes of containers and colors of foods.

18. The non-transitory calorie estimation program according to claim 17, wherein the classifying of the shape of the detected container comprises detecting a maximum width and a maximum length of the detected container, and determining whether a ratio of the maximum length to the maximum width is larger than an aspect ratio threshold.

19. The non-transitory calorie estimation program according to claim 18, wherein the classifying of the container shape comprises detecting a center point at which the maximum length and the maximum width intersect, and wherein the classifying of the container comprises classifying the shape of the container according to a ratio of an upper segment to a lower segment, wherein the upper segment is an entire portion of the maximum length above the center point and the lower segment is an entire portion of the maximum length below the center point

20. The non-transitory calorie estimation program according to claim 18, wherein the classifying of the container shape comprises detecting a center point at which the maximum length and the maximum width intersect, and wherein the detecting of the color of the food comprises detecting a color of a predetermined inner area around the center point as the color of the food.
